(19) United States
(12) Patent Application Publication
(10) Pub. No.: US 2026/0135711 A1
(43) Pub. Date: May 14, 2026

(54) INFORMATION PROCESSING METHOD, INFORMATION PROCESSING SYSTEM, AND STORAGE MEDIUM

(71) Applicant: DENSO CORPORATION, Kariya-city (JP)

(72) Inventor: Xin XU, Kariya-city (JP)

(21) Appl. No.: 19/429,764

(22) Filed: Dec. 22, 2025

Related U.S. Application Data
(63) Continuation of application No. PCT/JP2024/018616, filed on May 21, 2024.

(30) Foreign Application Priority Data
Jun. 29, 2023 (JP) 2023-107364

(51) Int. Cl. H04L 9/32; H04L 9/00

(52) U.S. Cl. CPC H04L 9/3236; H04L 9/50

(57) ABSTRACT

An information processing system comprises: a first acquisition unit configured to, when providing provision data from a provider system to a user system by using a data provision platform, acquire a first hash value generated using the provision data from the provider system; a second acquisition unit configured to acquire a second hash value generated using the provision data acquired by the user system from the user system; and a detection unit configured to detect tampering with the provision data based on comparison of the first hash value and the second hash value.

### CROSS REFERENCE TO RELATED APPLICATIONS

The present application is a continuation application of International Patent Application No. PCT/JP2024/018616 filed on May 21, 2024, which designated the U.S. and claims the benefit of priority from Japanese Patent Application No. 2023-107364 filed on June 29, 2023. The entire disclosures of all of the above applications are incorporated herein by reference.

### TECHNICAL FIELD

The present disclosure relates to an information processing technology for transferring data.

### BACKGROUND

A method of transmitting data encrypted by secure computation in order to ensure data privacy has been known as a comparative example. By using such secure computation, it becomes possible to protect data from unauthorized access and tampering while ensuring privacy.

### SUMMARY

An information processing system comprises at least one of (i) a circuit and (ii) a processor with a memory storing computer program code executable by the processor, the at least one of the circuit and the processor configured to cause the information processing system to: when providing provision data from a provider system to a user system by using a data provision platform, acquire a first hash value generated using the provision data from the provider system; acquire a second hash value generated using the provision data acquired by the user system from the user system; and detect tampering with the provision data based on comparison of the first hash value and the second hash value.

### BRIEF DESCRIPTION OF DRAWINGS

FIG. 1 is a block diagram showing an overview of a blockchain platform in which an information processing method according to one embodiment of the present disclosure is executed.

FIG. 2 is a diagram for illustrating details of provision data transferred by a data exchange system.

FIG. 3 is a flowchart showing details of a provision data registration process executed by a provider system.

FIG. 4 is a sequence diagram showing details of a sub-process of registering provision data in a data connector.

FIG. 5 is a flowchart showing details of a provision data acquisition process executed by a user system.

FIG. 6 is a sequence diagram showing details of a sub-process of acquiring the provision data from the data connector.

FIG. 7 is a sequence diagram showing details of a sub-process of confirming that tampering with provision data has not been performed.

FIG. 8 is a flowchart showing details of a tampering check process executed for past provision data.

### DETAILED DESCRIPTION

The method using secure computation of the comparative example can also be applied to a system in which data is provided from a client system to a data storage platform. However, when data is transferred between client systems, the size of encrypted data increases in a method using secure computation even when the data can be protected while the trade secret is maintained. As a result, it may be difficult to ensure the convenience of data transfer since the cost required for calculation and communication increases.

One example of the present disclosure provides an information processing method, an information processing system, and a storage medium capable of ensuring convenience of data transfer between client systems.

According to an aspect of the present disclosure, an information processing method is for transferring data between a plurality of client systems associated with a data storage platform, and comprises a process that is executed by at least one processor and includes: when providing provision data from a provider system to a user system by using a data provision platform, acquiring a first hash value generated using the provision data from the provider system; acquiring a second hash value generated using the provision data acquired by the user system from the user system; and detecting tampering with the provision data based on comparison of the first hash value and the second hash value.

Further, according to another of the present disclosure, an information processing system is for transferring data between a plurality of client systems associated with a data storage platform, and comprises: a first acquisition unit configured to, when providing provision data from a provider system to a user system by using a data provision platform, acquire a first hash value generated using the provision data from the provider system; a second acquisition unit configured to acquire a second hash value generated using the provision data acquired by the user system from the user system; and a detection unit configured to detect tampering with the provision data based on comparison of the first hash value and the second hash value.

Further, according to another of the present disclosure, a storage medium stores an information processing program for transferring data between a plurality of client systems associated with a data storage platform and readable by a computer, the information processing program causing at least one processor to execute a plurality of processes of: when providing provision data from a provider system to a user system by using a data provision platform, acquiring a first hash value generated using the provision data from the provider system; acquiring a second hash value generated using the provision data acquired by the user system from the user system; and detecting tampering with the provision data based on comparison of the first hash value and the second hash value.

In these aspects, a data provision platform is used to provide data from the provider system to the user system, so a trade secret can be maintained for the data storage platform. In addition, since tampering with the provision data can be detected by comparing the hash values, it is possible to protect the provision data. Furthermore, since the size of the provision data and each hash value are smaller than encrypted data for secure computation, it is possible to avoid an increase in the cost required for calculation and communication. Accordingly, it is possible to ensure the convenience of data transfer between client systems.

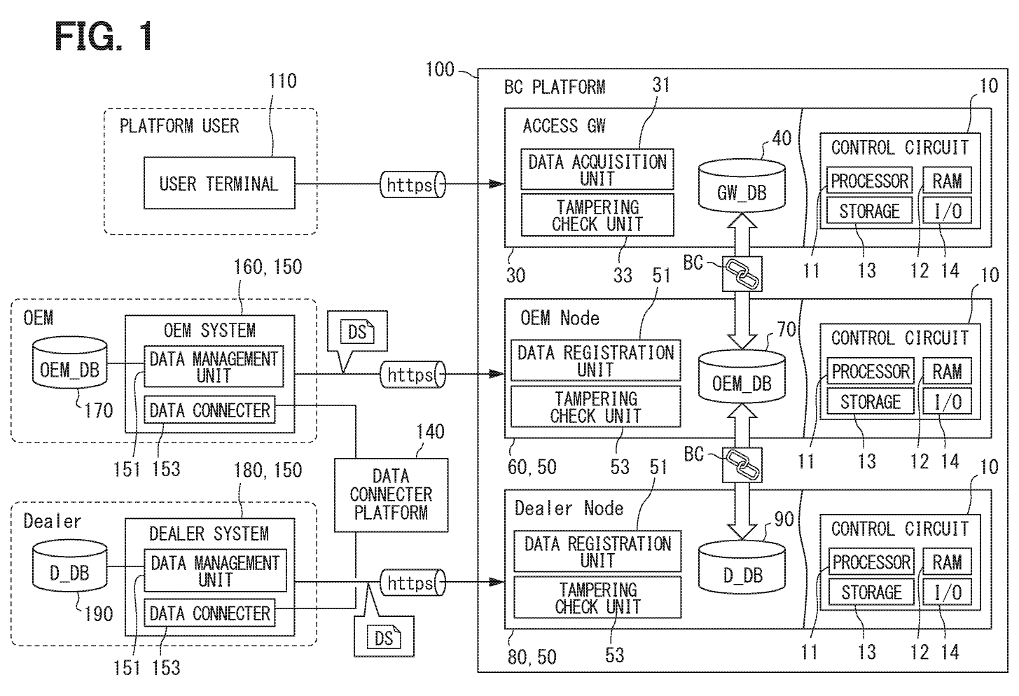

A blockchain platform 100 according to one embodiment of the present disclosure shown in FIG. 1 enables information sharing between clients (for example, companies) that become participants using a technology of a blockchain BC. For example, a framework of a general-purpose blockchain BC such as Hyperledger Fabric is used for the blockchain platform 100. In the blockchain platform 100, a private blockchain network (hereinafter referred to as a channel) can be established in which only specific participants can participate in the network and share data and transactions. As described above, it is possible to satisfy the privacy and confidentiality requirements of each participant.

The blockchain platform 100 includes multiple nodes 50 and at least one access gateway 30. Each node 50 and the access gateway 30 are constructed by, as one example, a blockchain server (virtual machine) on the cloud. The blockchain server mainly includes a control circuit 10. The control circuit 10 includes a processor 11, a RAM 12, a storage 13, an input/output interface 14, and a bus connecting these components, and functions as a high-performance computer that executes calculation processing at high speed.

The processor 11 is hardware for calculation processing coupled with the RAM 12. The processor 11 accesses the RAM 12 to execute various processes (instructions) related to data management and data provision. The storage 13 stores an information processing program that implements functions related to data management and provision. The information processing program is a program for causing a blockchain server (control circuit 10) to implement the information processing method of the present disclosure.

The node 50 is a blockchain management system associated with an individual client system 150. In one example, in a blockchain network that manages vehicle information, a client is an automobile manufacturer (Original Equipment Manufacturer, OEM) that manufactures the vehicle, a dealer that sells the vehicle, or the like. Among the multiple nodes 50, a node 50 that cooperates with the OEM management system (OEM system 160) is an OEM node 60. Further, the node 50 that cooperates with the dealer management system (dealer system 180) is a dealer node 80.

The OEM node 60 includes an OEM database 70. The OEM database 70 stores storage target data DS associated with the OEM and enables the storage target data DS to be shared with other nodes 50. Similarly, the dealer node 80 includes a dealer database 90. The dealer database 90 stores the storage target data DS associated with the dealer, and enables the storage target data DS to be shared with other nodes 50. The storage target data DS is data stored and shared on the blockchain platform 100 using the technology of the blockchain BC. The storage target data DS is collected in each client system 150 and transmitted to the node 50 associated with each client system 150.

The node 50 receives new registration requests, update requests, reference requests, and deletion requests for the storage target data DS from the client system 150. The node 50 includes a data registration unit 51. The data registration unit 51 is a functional unit constructed in the node 50. The data registration unit 51 receives a new registration request for the storage target data DS from the client system 150. The data registration unit 51 executes a registration process of the storage target data DS based on the registration request.

The data registration unit 51 stores the storage target data DS in a specific channel of the blockchain BC. The channel of the blockchain BC storing the storage target data DS is a public channel in which data is shared with other nodes 50 and the access gateway 30. The individual blocks constituting the blockchain BC store the storage target data DS as a transaction. In the blockchain BC, the hash value generated from one block is stored in the next block. Furthermore, time stamp data indicating the date and time when storage target data DS is added is recorded in each block.

The access gateway 30 is provided separately from each node 50, and manages access to the blockchain platform 100 by an external system or user (user terminal 110). The access gateway 30 performs authentication and authorization of connection to the blockchain platform 100 by the external system or the user terminal 110. The access gateway 30 includes a data acquisition unit 31 and a gateway database 40.

The data acquisition unit 31 is a functional unit constructed in the access gateway 30. The data acquisition unit 31 acquires reference requests and the like for the storage target data DS stored by the blockchain BC from the external system, the user terminal 110, and the like. The data acquisition unit 31 generates reference data from the storage target data DS based on the reference request, and provides the generated reference data to the external system or user terminal 110 that is the request source.

The gateway database 40 is a data storage area that stores information related to the access gateway 30. At least a part of the data stored in the gateway database 40 is shared with the OEM database 70, the dealer database 90, and the like by the function of the blockchain BC.

### Details of Data Exchange System

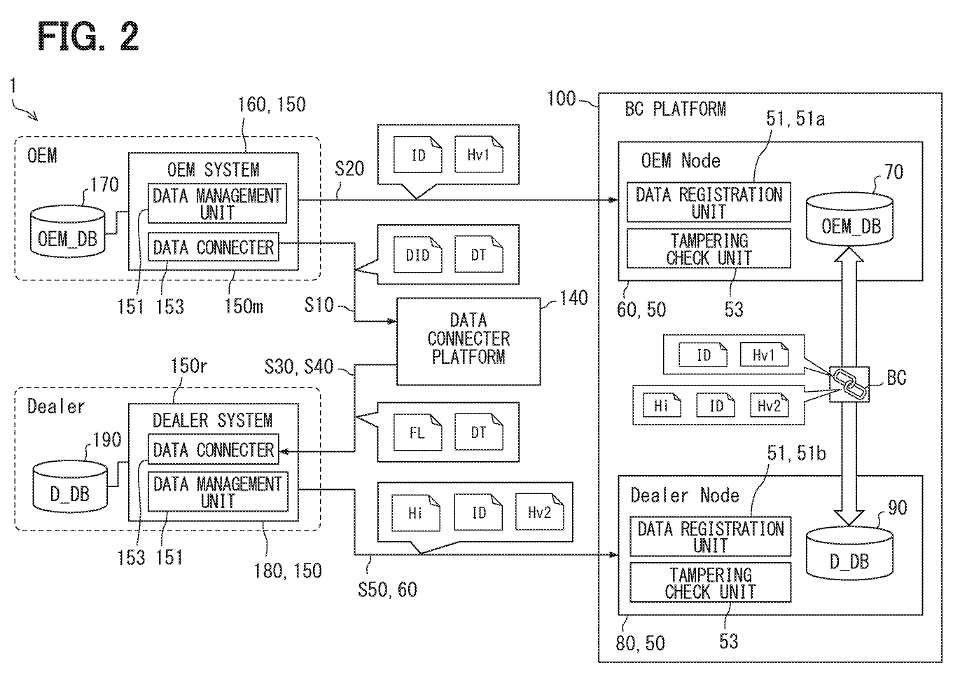

The client system 150 and the blockchain platform 100 described above construct a data exchange system 1 shown in FIG. 2 together with a data connector platform 140. The data exchange system 1 is a system for responding to a request of a client who cannot trust the operator of the blockchain platform 100 and does not want to pass their trade secret (raw data) to the blockchain platform 100.

The data exchange system 1 enables data to be transferred between multiple client systems 150 associated with the blockchain platform 100 without passing through the blockchain platform 100. In the data exchange system 1, a function of sharing data between clients by data connector technology and a function of tampering check by blockchain technology are integrated. In the data exchange system 1, the sovereignty of each client's data is protected, and the authenticity (reliability) of the data to be transferred is also guaranteed.

The client system 150 mainly includes a server device. The server device is a calculation processing device including a processor, a RAM, a storage, and the like. The client system 150 individually stores client data including trade secrets using client databases such as an OEM database 170 and a dealer database 190. The client database is, as an example, constructed in an object storage provided in the cloud. The object storage is a storage that stores files and data as objects, and can permanently store large amounts of data. As the object storage, for example, S3 (Simple Storage Service) of AWS (Amazon Web Services, registered trademark), Azure Blob Storage of Azure (registered trademark), and the like can be used.

The client system 150 transfers data relayed by the data connector platform 140 to other client systems 150. As one example, data (hereinafter referred to as provision data DT) can be transferred from the OEM system 160 to the dealer system 180. In this case, the OEM system 160 becomes a provider system 150m, and the dealer system 180 becomes a user system 150r.

In the blockchain platform 100 that manages vehicle information, the client system 150 collects approval information, asset information, access information, ID information, public key information, and the like together with vehicle information. This vehicle information may include a vehicle body number, year, grade, vehicle name, traveling distance, collision detection result, registered inspection result, registered photograph, assessment price, and the like. Among these pieces of information, information that corresponds to a trade secret, in other words, information that is not included in the storage target data DS may be set as appropriate by determination of the client such as the OEM and the dealer.

The client system 150 functioning as the provider system 150m and the user system 150r includes a data connector 153 and a data management unit 151. The data connector 153 is a functional unit (data-connect-manager) for using the data connector platform 140. The data management unit 151 is a functional unit for using the blockchain platform 100.

The data connector 153 of the provider system 150m (OEM system 160) registers at least a part of various client data (OEM data) corresponding to the trade secret in the data connector platform 140. The data connector 153 sets the client data that can be provided to other clients as provision data DT, and registers it in the data connector platform 140 in association with unique identification information (hereinafter referred to as data ID) that identifies this provision data DT (S10 in FIG. 2). The data ID may be general ID information issued by a specific ID issuer, or may be a distributed ID (DID) issued using blockchain BC technology. The data connector 153 may register metadata indicating the content of the provision data DT in the data connector platform 140 instead of the data body of the provision data DT.

The data management unit 151 of the provider system 150m selects, as the storage target data DS, information that does not correspond to trade secrets among the client data (OEM data) managed by the OEM system 160. The data management unit 151 registers the selected storage target data DS in the blockchain platform 100.

The data management unit 151 generates a first hash value Hv1 when the cloud data corresponding to the trade secret is registered in the data connector platform 140 as the provision data DT. The first hash value Hv1 is a hash value generated using the provision data DT registered in the data connector platform 140. The first hash value Hv1 is data in which a predetermined number of bits (for example, 256 bits) are maintained and has a value in which the content of the provision data DT is reflected. The data management unit 151 calculates the first hash value Hv1 by a calculation process that substitutes the provision data DT for a hash function such as SHA-256, for example. The data management unit 151 uploads the first hash value Hv1 to the OEM node 60 in association with a data ID that identifies the original data (provision data DT) (S20 in FIG. 2). The data registration unit 51 of the OEM node 60 executes a process of acquiring the first hash value Hv1 and data ID based on a request from the data management unit 151. The data registration unit 51 registers the first hash value Hv1 acquired from the provider system 150m in the blockchain platform 100 in association with the data ID.

The data connector 153 of the user system 150r (dealer system 180) can acquire trade secrets for other clients via the data connector platform 140. When the data connector 153 acquires the trade secret of another client, the data connector 153 acquires a file list FL from the data connector platform 140 (S30 in FIG. 2).

The file list FL records what kind of data other client systems 150 possess. That is, the list of provision data DT that can be acquired through the data connector platform 140 is shown in the file list FL. In this file list FL, a data ID for identifying each data is further described. The data connector 153 searches the file list FL, and identifies whether the data required by the own client (dealer) can be acquired from the data connector platform 140, a data acquisition source that is the client system 150, and the like.

When the data connector 153 is able to search for the necessary data from the file list FL, it extracts a data ID associated with the searched data, in other words, a data ID indicating the provision data DT from the file list FL. The data connector 153 acquires the desired provision data DT from the data connector platform 140 by designating a data ID (S40 in FIG. 2). When the data connector platform 140 does not store the data body of the provision data DT, the data connector 153 may acquire the data body of the provision data DT from the data connector 153 of the provider system 150m.

The data management unit 151 of the user system 150r, similarly to the data management unit 151 of the provider system 150m, selects client data (dealer data) that does not correspond to trade secrets, as the storage target data DS. The data management unit 151 registers the selected storage target data DS in the blockchain platform 100. In addition, when the data connector 153 acquires the provision data DT from the data connector platform 140, the data management unit 151 generates history information Hi and a second hash value Hv2.

The history information Hi is information indicating details of the transfer of the provision data DT from the provider system 150m to the user system 150r via the data connector platform 140. In the history information Hi, at least information such as what content provision data DT was acquired by the user system 150r and the acquired time, and which client system 150 provided the acquired provision data DT is recorded. The data ID may be used for information indicating the content of the provision data DT. The data management unit 151 registers the generated history information Hi in the blockchain platform 100 (S50 in FIG. 2).

The second hash value Hv2 is a hash value generated using the provision data DT acquired by the data connector 153. The second hash value Hv2 is data in which a predetermined number of bits (for example, 256 bits) are maintained and is a unique value in which the content of the provision data DT is reflected. The data management unit 151 calculates the second hash value Hv2 using the hash function used by the data management unit 151 of the provider system 150m to generate the first hash value Hv1. That is, the hash function used to generate the second hash value Hv2 is the same as the hash function used to generate the first hash value Hv1. The data management unit 151 registers the second hash value Hv2 in the blockchain platform 100 in association with the data ID (S60 in FIG. 2).

An encryption algorithm (hash function) of SHA-1, SHA-2, SHA-3 and the like instead of SHA-256 may be used to generate the first hash value Hv1 and the second hash value Hv2.

The blockchain platform 100 guarantees the authenticity of the provision data DT exchanged (data exchange) between each client system 150 in a system in which trade secrets are distributed and managed for each client. The node 50 includes a tampering check unit 53 in addition to the data registration unit 51 described above. Here, for convenience, the data registration unit 51 of the node 50 (OEM node 60) associated with the provider system 150m is referred to as a "first data registration unit 51a". Further, the data registration unit 51 of the node 50 (dealer node 80) associated with the user system 150r is referred to as a "second data registration unit 51b".

The first data registration unit 51a acquires a large number of first hash values Hv1 generated using the provision data DT registered in the data connector platform 140 from the client system 150 (provider system 150m) together with the data ID. The first data registration unit 51a stores the first hash value Hv1 in the OEM database 70 in association with the data ID.

The second data registration unit 51b acquires the second hash value Hv2 generated using the provision data DT acquired by the client system 150 (user system 150r) from this user system 150r. The second data registration unit 51b acquires the second hash value Hv2 together with the data ID that identifies the provision data DT. The second data registration unit 51b stores the second hash value Hv2 in the dealer database 90 in association with the data ID.

The second data registration unit 51b acquires, from the user system 150r, history information Hi that records the exchange of provision data DT between the data connector platform 140 and each data connector 153. The second data registration unit 51b stores the history information Hi in the dealer database 90 in association with the second hash value Hv2 and its data ID.

The first hash value Hv1, the second hash value Hv2, the data ID, and the history information Hi stored in the OEM database 70 and the dealer database 90 are registered in the blockchain BC and are tampering-resistant.

The tampering check unit 53 is a functional unit of the blockchain platform 100. The tampering check unit 53 detects tampering with the provision data DT based on comparison of the first hash value Hv1 and the second hash value Hv2. The tampering check process of the provision data DT is executed by the tampering check unit 53 of the node 50 (dealer node 80 in FIG. 2) associated with the user system 150r. The tampering check unit 53 uses the data ID acquired by the second data registration unit 51b to extract the first hash value Hv1 associated with the provision data DT transferred this time from among the many first hash values Hv1 registered in the blockchain BC.

As described above, the tampering check unit 53 prepares the first hash value Hv1 and the second hash value Hv2 for comparison. When the first hash value Hv1 and the second hash value Hv2 are the same value, the tampering check unit 53 determines that the tampering with the provision data DT has not been performed. On the other hand, when the first hash value Hv1 and the second hash value Hv2 are different, the tampering check unit 53 determines that the tampering with the provision data DT has been performed.

The data connector platform 140 cooperates with each data connector 153 of each client system 150 to enable data exchange between the client systems 150. As one example, a data sharing ecosystem such as Gaia-X and Catena-X can be used for the data connector platform 140. The data connector platform 140 has a registration function of the client system 150, and manages connection to the data connector platform 140 by the data connector 153.

The data connector platform 140 protects data sovereignty for each client. Even when the provision data DT is transferred from the provider system 150m to the user system 150r, the data connector platform 140 leaves the data sovereignty of the provision data DT in the provider system 150m. The data sovereignty is a concept that encompasses ownership and control over data. By leaving the data sovereignty in the provider system 150m, the provider system 150m has the right to control (restrict) the storage, editing, deletion, use, sharing, and the like of the provision data DT.

### Details of Processes Executed by Data Exchange System

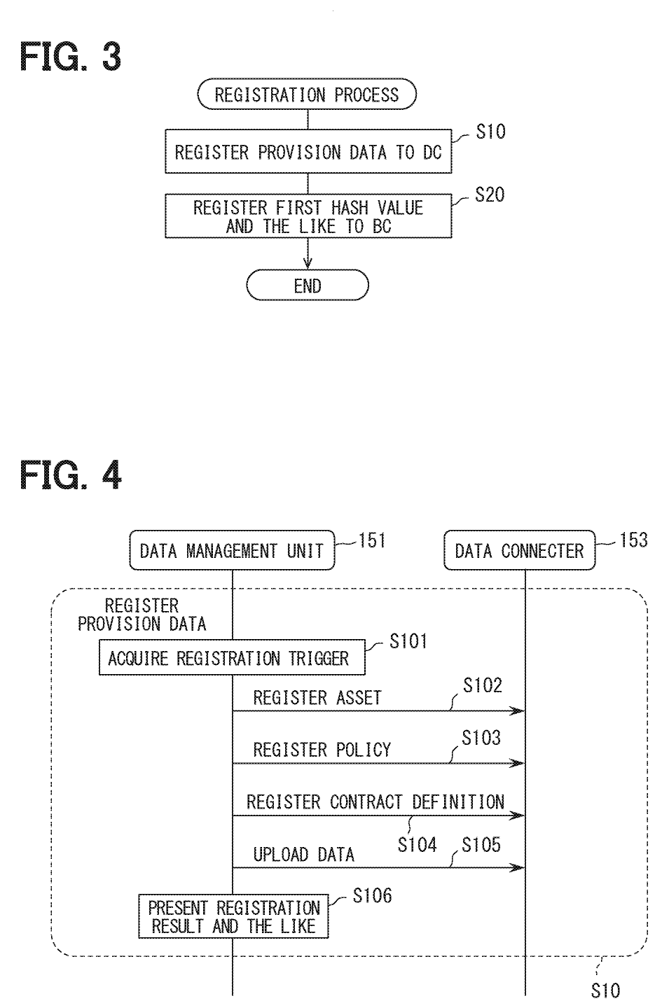

Next, details of each of the registration process and the acquisition process executed in the data exchange system 1 described so far will be described based on FIGS. 3 to 7 with reference to FIG. 2.

The registration process of the provision data DT shown in FIG. 3 is mainly executed by the provider system 150m. In S10, the data management unit 151 and the data connector 153 of the provider system 150m register client data, which can be provided to other client systems 150, as the provision data DT in the data connector platform 140. Furthermore, in S20, the data management unit 151 registers, in the blockchain platform 100, the first hash value Hv1 based on the provision data DT registered in the data connector platform 140 together with the data ID. The execution order of S10 and S20 in the registration process may be changed.

In S101 of the sub-process of the registration process (S10) shown in FIG. 4, the data management unit 151 acquires a trigger to register the provision data DT. In one example, when a user (worker) belonging to a client performs a user operation for instructing data registration, the data registration unit 51 acquires a registration trigger. Further, as another example, even when client data of a preset registration target type is acquired, the data registration unit 51 acquires the registration trigger.

In S102 and S103, the data management unit 151 registers the data asset and data policy of the provision data DT that are registration targets in the data connector 153. Further, the data management unit 151 registers the contract definition in the data connector 153 in S104. The contract definition is information indicating conditions and rules related to the data exchange of the provision data DT that is the registration target.

In S105, the data management unit 151 uploads the data body of the provision data DT to the data connector 153. In S106, the data management unit 151 presents the registration result of the provision data DT to the user and stores the registration history in the client database. As described above, the provision data DT can be transferred using the data connector 153 and the data connector platform 140.

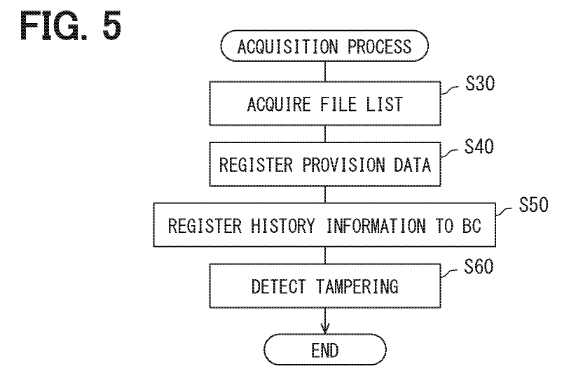

The acquisition process of the provision data DT shown in FIG. 5 is mainly executed by the user system 150r. The data management unit 151 and the data connector 153 of the user system 150r acquire the file list FL from the data connector platform 140 in S30. Furthermore, the data management unit 151 and the data connector 153 acquire the necessary provision data DT in S40.

In S50, the data management unit 151 generates history information Hi indicating the acquisition history of the provision data DT, and registers it in the blockchain platform 100. Furthermore, in S60, the data management unit 151 cooperates with the data registration unit 51 of the node 50 (dealer node 80) to check whether the tampering with the provision data DT acquired in S40 has not been performed.

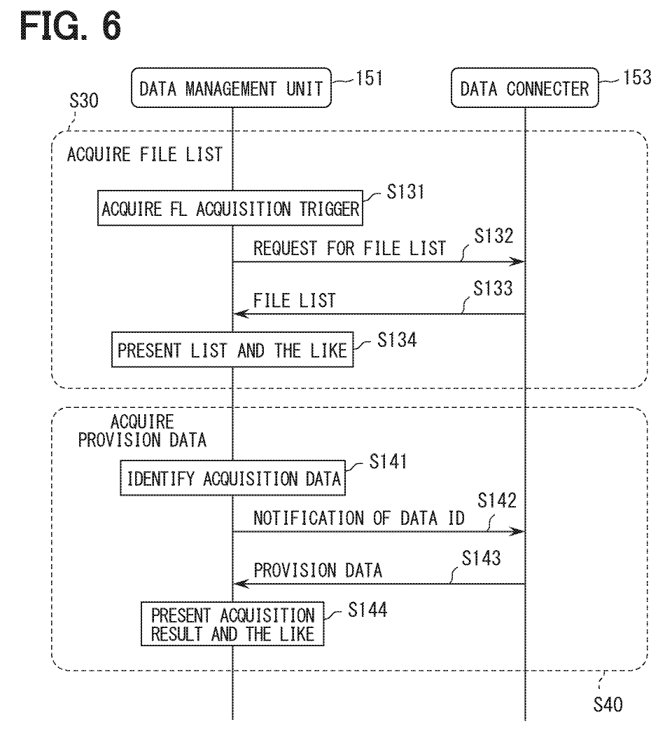

In S131 of the sub-process of the acquisition process (S30, S40) shown in FIG. 6, the data management unit 151 acquires a trigger to acquire the file list FL. In one example, when a user (worker) belonging to the client performs a user operation for instructing acquisition of the file list FL, the data registration unit 51 acquires the acquisition trigger. The data management unit 151 requests the data connector 153 to provide the file list FL in S132. The data connector 153 cooperates with the data connector platform 140 to provide the file list FL to the data management unit 151 in S133. In S134, the data management unit 151 presents the contents of the file list FL to the user and stores the file list FL in the client database.

The data management unit 151 identifies the provision data DT to be acquired in S141. In one example, the data management unit 151 determines the provision data DT based on the user operation. In S142, the data management unit 151 notifies the data connector 153 of the data ID, thereby requesting provision of the provision data DT that is the acquisition target. The data connector 153 cooperates with the data connector platform 140 to provide the specified provision data DT to the data management unit 151 in S143. In S144, the data management unit 151 presents the acquisition result of the provision data DT to the user and stores the provision data DT in the client database.

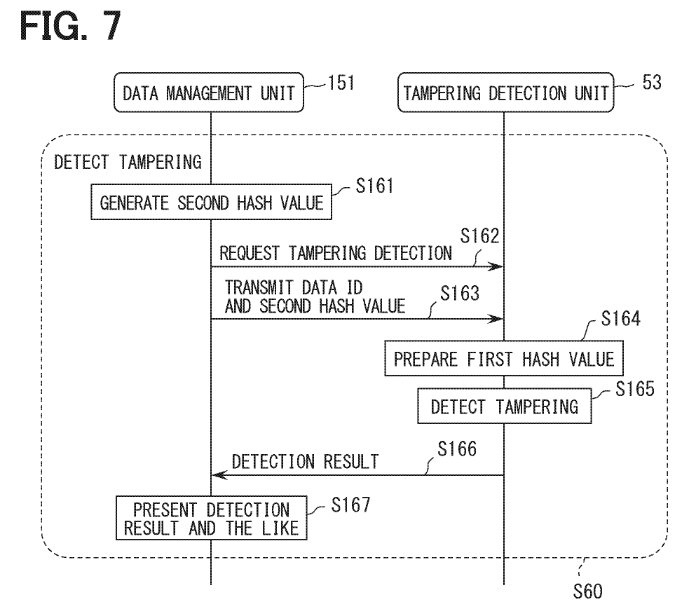

In a sub-process of the acquisition process (S60) shown in FIG. 7, a tampering check of the provision data DT is performed. Specifically, in S161, the data management unit 151 generates a second hash value Hv2 based on the provision data DT acquired in S40. In S162, the data management unit 151 transmits a tampering detection execution request to the data connector 153. In S163, the data management unit 151 transmits the data ID and the second hash value Hv2 necessary for tampering detection to the tampering check unit 53.

The tampering check unit 53 executes the process of acquiring the data ID and the second hash value Hv2 in S163. In S164, the tampering check unit 53 extracts the first hash value Hv1 associated with the acquired data ID from the information obtained by data sharing by the blockchain BC, and prepares the first hash value Hv1 and the second hash value Hv2 for comparison. Then, in S165, the tampering check unit 53 detects tampering of the provision data DT based on the comparison of the first hash value Hv1 and the second hash value Hv2. The tampering check unit 53 notifies the data management unit 151 of the tampering detection result in S166.

The data management unit 151 acquires the result of the tampering detection by the tampering check unit 53 in S166. In S167, the data management unit 151 presents the acquired detection result to the user and stores this detection result in the client database.

### Tampering Check Process for Past Data Exchange

The access gateway 30 shown in FIG. 1 includes a tampering check unit 33 in addition to the data acquisition unit 31. The tampering check unit 33 is a functional unit of the blockchain platform 100. The tampering check unit 33 has a tampering detection function similar to the tampering check unit 53 provided in the node 50. The tampering check unit 33 verifies whether tampering has been performed on the past data exchange performed in the data exchange system 1, in other words, the past provision data DT.

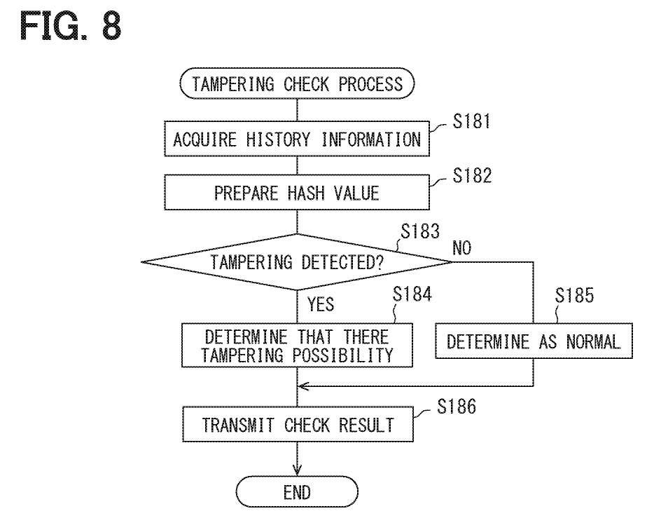

Hereinafter, details of the tampering check process executed by the tampering check unit 33 for exchanging data for the past will be described based on FIG. 8 with reference to FIGS. 1 and 2. The tampering check process shown in FIG. 8 starts based on the tampering check request acquired by the data acquisition unit 31, for example.

In S181 of the tampering check process, the tampering check unit 33 acquires the history information Hi of the data exchange performed by the data exchange system 1 from the information obtained by data sharing by the blockchain BC. The tampering check unit 33 recognizes the data ID of the provision data DT transferred in the past data exchange based on the history information Hi.

In S182, the tampering check unit 33 acquires the first hash value Hv1 uploaded from the provider system 150m and the second hash value Hv2 uploaded from the user system 150r by using the data ID. In S182, the first hash value Hv1 and the second hash value Hv2 are prepared for comparison by data sharing using the blockchain BC. For all data exchanges performed in the past, the tampering check unit 33 extracts pairs of the first hash value (Hv1) and the second hash value (Hv2) that correspond to each other.

In S183, the tampering check unit 33 detects tampering of the provision data DT based on the comparison of the first hash value Hv1 and the second hash value Hv2. When the tampering check unit 33 detects no matching (inconsistency) between the first hash value Hv1 and the second hash value Hv2 for at least a part of the data exchange (YES in S183), it determines that there is a possibility of tampering in S184. In this case, in S186, the tampering check unit 33 transmits a check result indicating that there is the possibility of tampering to the external system or the user terminal 110 or the like that is the request source of the tampering check.

On the other hand, for all data exchanges, when the first hash value Hv1 and the second hash value Hv2 match (are consistent) (NO in S183), the tampering check unit 33 determines that there is no possibility of tampering and the data is normal in S185. In this case, in S186, the tampering check unit 33 transmits a check result indicating that tampering has not been detected to the external system or the user terminal 110 or the like that is the request source of the tampering check.

### Overview of Embodiment

In the present embodiment described so far, since the data connector platform 140 is used to provide data from the provider system 150m to the user system 150r, the trade secret can be maintained with respect to the blockchain platform 100. In addition, since the tampering with the provision data DT can be detected by comparing the hash values, it becomes possible to protect the provision data DT. Furthermore, the size of the provision data DT, the first hash value Hv1, and the second hash value Hv2 are smaller than the encrypted data for the secure computation. Therefore, it is possible to avoid an increase in the cost required for calculation and communication. Accordingly, it is possible to ensure the convenience of data transfer between the client systems 150.

In addition, in the present embodiment, the sovereignty of the provision data DT remains in the provider system 150m even when the provision data DT is provided from the provider system 150m to the user system 150r. Therefore, even when data can be exchanged between the client systems 150, the data sovereignty of the client data, which is the trade secret, can be protected.

Further, in the present embodiment, in the blockchain platform 100, the first hash value Hv1 and the second hash value Hv2 are prepared for comparison by data sharing using the blockchain BC. As described above, by using the blockchain BC technology for data sharing, the first hash value Hv1 and the second hash value Hv2 can be protected from the tampering. Therefore, it is possible to more accurately detect the tampering with the provision data DT using these hash values.

As described above, in the present embodiment, the data sovereignty of the provider system 150m is protected by utilizing the technology of the data connector. Furthermore, by utilizing the technology of the blockchain BC, it is ensured that the tampering with the transferred provision data DT has not been performed. Accordingly, it is possible to implement the data exchange system 1 that both protects data sovereignty and ensures data authenticity.

Furthermore, the tampering detection process of the provision data DT in the present embodiment is executed in response to the reception of the provision data DT by the user system 150r via the data connector platform 140 (see S60 in FIG. 5). According to the above, the user system 150r can quickly grasp whether the tampering has not occurred in the acquired provision data DT.

In addition, the blockchain platform 100 of the present embodiment acquires the history information Hi of the transfer of the provision data DT from the provider system 150m to the user system 150r via the data connector platform 140 (see S50 in FIG. 5). Therefore, even in a system configuration in which the blockchain platform 100 is not directly involved in the transfer of the provision data DT, it is possible to leave the exchange history of the provision data DT under the protection of the blockchain BC.

Further, in the present embodiment, based on the history information Hi, a process of detecting tampering is executed on the past provision data DT (see FIG. 8). According to the above, it is possible to comprehensively check whether the tampering has occurred in the past data exchange at an appropriate time by third party organizations or the like that have not exchanged the provision data DT.

Specifically, the provider system 150m registers a hash value of information indicating a transmission timing, a transmission destination, and a type of the transmitted data in the history information Hi. Further, the user system 150r registers a hash value of information indicating the reception timing, the transmission source, and the type of received data in the history information Hi. According to the tampering detection process of comprehensively checking the past history information Hi, in addition to ensuring the authenticity of the data itself, it is possible to confirm that the tampering with the data exchange time, exchange of approval information, and the like have not been performed.

In the above embodiment, the tampering check unit 33 and the tampering check unit 53 correspond to a "detection unit", the first data registration unit 51a corresponds to a "first acquisition unit", and the second data registration unit 51b corresponds to a "second acquisition unit". Further, the data exchange system 1 corresponds to an "information processing system", the blockchain platform 100 corresponds to a "data storage platform", and the data connector platform 140 corresponds to a "data provision platform".

### Other Embodiments

Although one embodiment of the present disclosure has been described above, the present disclosure is not construed as being limited to the above-described embodiment, and can be applied to various embodiments and combinations within a scope that does not depart from the gist of the present disclosure.

In a first modification of the above embodiment, instead of the blockchain platform 100, a data storage platform that does not utilize the technology of the blockchain BC is used. Further, in a second modification of the above embodiment, the tampering detection process at the timing when the provision data DT is transferred is executed by the tampering check unit 33 of the access gateway 30 instead of the tampering check unit 53 of each node 50.

The execution timing of the step of detecting the tampering with the provision data DT may be changed as appropriate. For example, in a third modification of the above embodiment, only the tampering detection process is executed at the timing when the provision data DT is transferred. The tampering detection process for past data exchange based on a request from a third party institution or the like is not executed. That is, the tampering check unit 33 of the access gateway 30 is omitted.

Further, in a fourth modification of the above embodiment, only the tampering detection process for past data exchange based on a request from the third party institution or the like is executed. The tampering detection process at the timing when the provision data DT is transferred is not executed. That is, the tampering check unit 53 of each node 50 is omitted.

In a fifth modification of the above embodiment, instead of the user system 150r, the data connector platform 140 provides the history information Hi of data exchange to the blockchain platform 100. Further, in a sixth modification of the above embodiment, instead of or together with the user system 150r, the provider system 150m provides the history information Hi to the blockchain platform 100.

In the above embodiment, the respective functions provided by the client system 150 and the like can be also provided by software and hardware for executing the software, only software, only hardware, and complex combinations of software and hardware. Similarly, the respective functions provided by the access gateway 30, the node 50, and the like can be also provided by software and hardware for executing the software, only software, only hardware, and complex combinations of software and hardware. Further, when these functions are provided by electronic circuits as hardware, each function can be provided by a digital circuit including a large number of logic circuits, or an analog circuit.

In the embodiment described above, the processor may include at least one processing core, such as a CPU (Central Processing Unit) or a GPU (Graphics Processing Unit). The processors may further include a field-programmable gate array (FPGA), a neural network processing unit (NPU), and/or an IP core with other dedicated functions. Additionally, each of the processors is not limited to being a chip configuration in which chips are individually mounted on a printed circuit board. The processors may be incorporated in an application specific integrated circuit (ASIC), a system on chip (SoC), or a FPGA.

The form of the storage medium (non-transitory tangible storage medium), which is employed as the storage in the above embodiment and stores each program, may be changed as appropriate. For example, the storage medium is not limited to the configuration provided on the circuit board, and may be provided in the form of a memory card or the like. The storage medium may be inserted into a slot portion, and electrically connected to a computer bus. The storage medium may be an optical disc, a hard disk drive, or the like used as a source of copying or distributing a program to a computer.

The controller and its methods described in the present disclosure may be implemented by a dedicated computer comprising a processor programmed to execute one or more functions embodied in a computer program. Alternatively, the device and the method thereof according to the present disclosure may be implemented by a dedicated hardware logic circuit. Alternatively, the device and the method thereof according to the present disclosure may be implemented by at least one dedicated computer implemented by a combination of a processor that executes a computer program and at least one hardware logic circuit. Additionally, the computer program may be stored in a computer-readable non-transitory tangible storage medium as instructions executed by a computer.

What is claimed is:

1. An information processing method executed by at least one processor for transferring data between a plurality of client systems associated with a data storage platform, the information processing method comprising:
when providing provision data from a provider system to a user system by using a data provision platform, acquiring a first hash value generated using the provision data from the provider system;
acquiring a second hash value generated using the provision data acquired by the user system from the user system; and
detecting tampering with the provision data based on comparison of the first hash value and the second hash value.

2. The information processing method according to claim 1, wherein
a sovereignty of the provision data remains in the provider system even when the provision data is provided from the provider system to the user system.

3. The information processing method according to claim 1, further comprising
sharing data using a blockchain on the data storage platform to perform comparison between the first hash value and the second hash value.

4. The information processing method according to claim 1, wherein
detecting the tampering with the provision data is executed in response to reception of the provision data by the user system via the data provision platform.

5. The information processing method according to claim 1, further comprising
acquiring history information indicating transfer of the provision data from the provider system to the user system via the data provision platform.

6. The information processing method according to claim 5, wherein
detecting the tampering with the provision data is executed on the provision data for a past time based on the history information.

7. An information processing system for transferring data between a plurality of client systems associated with a data storage platform, the information processing system comprising
at least one of (i) a circuit and (ii) a processor with a memory storing computer program code executable by the processor, the at least one of the circuit and the processor configured to cause the information processing system to:
when providing provision data from a provider system to a user system by using a data provision platform, acquire a first hash value generated using the provision data from the provider system;
acquire a second hash value generated using the provision data acquired by the user system from the user system; and
detect tampering with the provision data based on comparison of the first hash value and the second hash value.

8. A non-transitory computer-readable storage medium storing an information processing program for transferring data between a plurality of client systems associated with a data storage platform and readable by a computer, the information processing program causing at least one processor to:
when providing provision data from a provider system to a user system by using a data provision platform, acquire a first hash value generated using the provision data from the provider system;
acquire a second hash value generated using the provision data acquired by the user system from the user system; and
detect tampering with the provision data based on comparison of the first hash value and the second hash value.
